(19) United States
(12) Patent Application Publication
(10) Pub. No.: US 2006/0202555 A1
(43) Pub. Date: Sep. 14, 2006

(54) Noise-reduced vehicle brake system

(75) Inventors: Andrew William Kingston, Waldesch (DE); Thomas Straub, Vallendar (DE); Salvatore Oliveri, Filsen (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive GmbH

(21) Appl. No.: 11/347,839

(22) Filed: Feb. 3, 2006

Related U.S. Application Data
(63) Continuation of application No. PCT/EP04/08446, filed on Jul. 28, 2004.

(30) Foreign Application Priority Data
Aug. 4, 2003 (DE) 103 35 616.9

(51) Int. Cl. B60T 8/32

(52) U.S. Cl. 303/191

(57) ABSTRACT

A method of automatically suppressing or preventing noise generation during the actuation of a vehicle brake system comprising two or more wheel brakes is described. For this purpose, a parameter that allows a conclusion to be drawn about noise generation is acquired and evaluated to detect the occurrence or imminent occurrence of noises. Should the evaluation reveal the occurrence and imminent occurrence of noises, the brake force distribution between the wheel brakes is changed. This change of the brake force distribution is effected while simultaneously retaining a desired and/or set vehicle deceleration.

### CROSS-REFERENCE TO RELATED APPLICATIONS

This application is a continuation of International Application No. PCT/EP2004/008446 filed Jul. 28, 2004, the disclosures of which are incorporated herein by reference, and which claims priority to German Patent Application No. DE 103 35 616.9 filed Aug. 4, 2003, the disclosures of which are incorporated herein by reference.

### BACKGROUND OF THE INVENTION

The invention relates to a method of automatically suppressing or preventing noise generation during the actuation of a vehicle brake system comprising two or more wheel brakes. The invention further relates to a noise-reduced vehicle brake system.

It is generally known that during the actuation of a vehicle brake system often noises occur that are perceived as unpleasant. One example that may be cited is the squealing that occurs in specific operating states of the vehicle brake system.

Various procedures are known for reducing or even pre-empting disturbing noises linked to the actuation of a vehicle brake system. As many instances of noise generation in vehicle brake systems are attributable to resonance effects, it has for example been proposed to dispose additional masses in the region of the wheel brakes. By means of the additional masses, critical resonant frequencies are shiftable into ranges that are not reached or reached only in exceptional situations upon an actuation of the vehicle brake system.

The provision of additional masses in the region of the wheel brakes is generally perceived as disadvantageous. One reason for this is the fact that the additionally provided masses for shifting the resonant frequencies increase the total unsprung mass of the motor vehicle. What is more, determining the resonant frequencies and locating a suitable position for mounting the additional masses during development of the brake involves a high outlay. From WO 92/07742, and corresponding U.S. Pat. No. 5,108,159, the disclosures of both of which are incorporated by reference herein, a method of suppressing noise generation in a vehicle brake system is known. In the vehicle brake system, a vibration sensor is associated with each wheel.

The vibration sensors make it possible to measure vibrations (and noises resulting therefrom) as a consequence of the brake shoes coming into abutment with a brake disk. As soon as the vibrations exceed a limit frequency of 8 Hz, by means of suitable control signals the pressure of a brake fluid is modulated at a predetermined frequency. Obviously, such pressure modulations are suitable for reducing the vibrations arising during the generation of the brake forces and reducing the noises linked to the vibrations.

From DE 198 04 676 A1 a further method of preventing noise generation in a vehicle brake system is known. In this method, the occurrence of noises is detected by measurement and the noises that occur are eliminated in accordance with the teaching of WO 92/07742 by modulating the brake pressure at one or more or all of the wheel brakes. Instead of a pulsating pressure modulation, a slight pressure increase of the or a pressure reduction may be adjusted. Should noises occur at several or all of the wheel brakes, the brake pressure may be increased at the wheel brakes of one of the vehicle axles and at the same time the brake pressure may be reduced at the wheel brakes of a further vehicle axle.

The underlying object of the invention is to indicate an efficient method of suppressing or preventing noise generation during the actuation of a vehicle brake system comprising two or more wheel brakes. A further underlying object of the invention is to indicate a vehicle brake system that allows the implementation of such a method.

### BRIEF SUMMARY OF THE INVENTION

According to the invention, for automatically suppressing or preventing noise generation during the generation of brake forces by means of the wheel brakes of a vehicle brake system it is proposed to acquire one or more parameters that allow a conclusion to be drawn about noise generation, to evaluate the parameter or parameters to detect the occurrence or imminent occurrence of noises and to change a brake force distribution when the evaluation reveals the occurrence or imminent occurrence of noises. Changing of the brake force distribution between the wheel brakes is effected in such a way that a vehicle deceleration desired by a driver or set by a control system is retained.

To suppress noises or prevent the occurrence of noises, according to the invention influence is therefore purposefully brought to bear upon the brake force distribution. This occurs advantageously in such a way that the one or more wheel brakes, in the region of which noise generation occurs or is to be expected, in a departure from the customary or planned actuation profile are actuated in such a way that the noise generation is counteracted.

To prevent the altered actuation operation of one or more of the wheel brakes from leading to a, for the driver, possibly surprising change of the vehicle deceleration, a brake force redistribution may be effected in such a way that the sum of all of the brake forces does not alter despite the changed actuation profile of one or more of the wheel brakes. The marginal condition of retaining the desired vehicle deceleration despite an intervention into the actuation profile of one or more of the wheel brakes leads, as a rule, to a change of the brake force distribution among all of the wheel brakes compared to a braking operation without this intervention to counteract noise generation.

The changed brake force distribution may also include a wheel brake, at which no noise generation occurs or is to be expected. In the case of a wheel brake affected by the noise generation, a change of the (standard) brake force distribution may involve the brake pressure, in the event of the occurrence or imminent occurrence of noise generation, not being increased further, i.e. being limited.

The at least one parameter that allows a conclusion to be drawn about possible noise generation is preferably evaluated for the existence or occurrence of a critical condition. The critical condition may be, for example, the reaching or exceeding of a threshold value. It is further conceivable for the critical condition to be defined in such a way that the at least one parameter lies within a critical parameter range. Should a plurality of parameters be used to detect the occurrence or imminent occurrence of noises, the critical condition may be defined individually for each parameter or jointly for a set of parameters.

The brake force distribution is advantageously changed if the critical condition is met or its occurrence is imminent. The change of the brake force distribution may be geared towards the critical condition no longer being met or its occurrence being prevented.

In the event of successive, noise-related changes of the brake force distribution, it is advantageous generally alternately to increase and reduce the brake force at one of the wheel brakes or axles. In this way, it is possible to avoid uneven wear. The wheel brakes or axles affected by the alternating brake force changes are advantageously in each case those at which no noise generation has to be counteracted.

For changing the brake force distribution, an additional control and/or regulating device may be provided. Preferably, however, this purpose is served by a pre-existing brake pressure regulating device that is provided also for other purposes. Examples that may be cited in this connection are the regulating devices of an antilock braking system (ABS), acceleration spin regulation (ASR) or an electronic stability program (ESP).

Changing the brake force distribution may be effected in different ways. For example, it is conceivable to use one or more characteristics maps in order, in the event of the occurrence or imminent occurrence of noises, to activate a predetermined brake force distribution or a predetermined brake force distribution profile. The brake force distribution may be effected in a controlled manner that simultaneously takes into consideration a change of the at least one acquired parameter that results from the changed brake force distribution (closed-loop control).

Various parameters may be acquired and evaluated to detect the occurrence or imminent occurrence of noises. The essential point here is that the considered parameter or parameters, individually or in combination, allow a conclusion to be drawn about noise generation. As a suitable parameter according to the invention, the output signal of a noise sensor or vibration sensor may for example be used. By means of a noise sensor (e.g. a microphone), noise generation is directly acquired. This means that noises have already occurred and are therefore detectable. The invention is geared in this case towards suppressing the noises or further, more extreme noise generation.

The wheel peripheral speed and/or associated wheel brake force may be cited as further examples of suitable parameters according to the invention. In practice, it has emerged that in the region of a wheel brake, in the event of critical combinations of wheel peripheral speed and wheel brake force, an undesirable generation of noise is to be expected. In the case of the acquisition and evaluation of wheel peripheral speed and associated wheel brake force, it is often possible to pre-empt the occurrence of undesirable noises.

Preferably, the acquisition or the evaluation or both the acquisition and the evaluation of the at least one parameter is effected in a wheel-related manner, i.e. individually for each wheel. It is however also possible to select an axle-related approach. Changing of the brake force distribution may be effected in an axle-related manner. A wheel-related change of the brake force distribution is however equally conceivable.

A vehicle brake system that is suitable for implementing the method according to the invention comprises two or more separately controllable wheel brakes, at least one sensor for acquiring at least one parameter that allows a conclusion to be drawn about noise generation, an evaluation device for evaluating the at least one parameter for the occurrence or imminent occurrence of noises, and a command-generating device. The last-mentioned device generates commands for changing a brake force distribution e.g. between the wheel brakes, should the evaluation reveal the occurrence or imminent occurrence of noises. As already mentioned, changing of the brake force distribution is effected while simultaneously retaining a desired or set vehicle deceleration.

The vehicle brake system according to the invention may be designed as a conventional hydraulic brake system or be based on the brake-by-wire principle. According to this principle, the braking request of a driver is supplied electrically or electronically, i.e. not hydraulically, to an actuator unit for the wheel brakes. This is the case, for example, in so-called electrohydraulic brake systems (EHB) or electromechanical brake systems (EMB).

The command-generating device of the vehicle brake system according to the invention may be a device specially provided for the purpose of suppressing or preventing noise generation. Preferably, however, the functionality of the command-generating device is fulfilled by a pre-existing brake pressure regulating device that is provided also for other purposes such as ABS, ASR or ESP.

Other advantages of this invention will become apparent to those skilled in the art from the following detailed description of the preferred embodiments, when read in light of the accompanying drawings.

### BRIEF DESCRIPTION OF THE DRAWINGS

FIG. 1 illustrates a first embodiment of a vehicle brake system according to the invention;

FIG. 2 is a schematic diagram relating to the change according to the invention of the brake force distribution between a rear axle and a front axle of a motor vehicle; and

FIG. 3 illustrates a second embodiment of a vehicle brake system according to the invention.

### DETAILED DESCRIPTION OF THE INVENTION

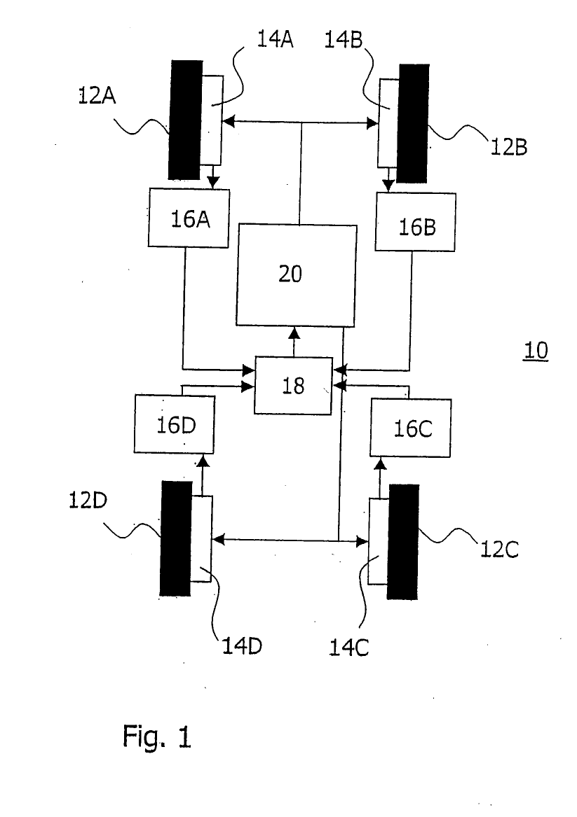

In FIG. 1 a first embodiment of a vehicle brake system 10 according to the invention is illustrated. The vehicle brake system 10 according to the invention is designed to interact with four wheels 12A, 12B, 12C, 12D of a motor vehicle. The two wheels 12A and 12B are disposed on the front axle (VA) of the motor vehicle and the two wheels 12C and 12D on the rear axle (HA).

The vehicle brake system 10 according to the invention comprises one wheel brake 14A. . . 14D for each wheel 12A. . . 12D. In the case of the example, the wheel brakes 14A. . . 14D are based on a hydraulic operating principle. This means that the brake force generation is based on the generation of a hydraulic pressure in the region of the individual wheel brakes 14A. . . 14D. The hydraulic pressure, also described as brake pressure, may be built up in accordance with the brake-by-wire principle by means of a hydraulic pump or in a conventional manner by the driver, using a master brake cylinder. The brake pressure may be built up wheel by wheel or axle by axle.

As FIG. 1 reveals, a sensor device 16A. . . 16D is associated with each of the wheel brakes 14A. . . 14D. The sensor devices 16A. . . 16D allow the determination of the wheel peripheral speed and the associated hydraulic wheel brake pressure for each wheel.

The vehicle brake system 10 according to the invention further comprises a central evaluation device 18 that evaluates the sensor signals of the sensor devices 16A. . . 16D (or more precisely: the individual wheel peripheral speeds and associated wheel brake pressures). The purpose of this evaluation is to detect the occurrence or imminent occurrence of noises.

The vehicle brake system 10 according to FIG. 1 further possesses a brake pressure regulating device 20 with ABS/ESP functionality.

Resonance effects are usually one of the main causes of the occurrence of undesirable brake noises. In this respect, a particular susceptibility to resonance effects is presented by the wheel brake/axle stub system. It has been found that the wheel brakes 14A. . . 14D and, more precisely, their brake linings from a mechanical viewpoint each represent a spring having properties dependent on the brake pressure. This means that the resonant frequencies of the wheel brake/axle stub system have a dependence upon the brake pressure. Undesirable resonance effects and associated noise generation occur whenever, because of a brake pressure change, a resonant frequency is shifted into a critical range in terms of excitation, i.e. for example, whenever the resonant frequency of a specific wheel brake/axle stub combination correlates with the peripheral speed of the corresponding wheel.

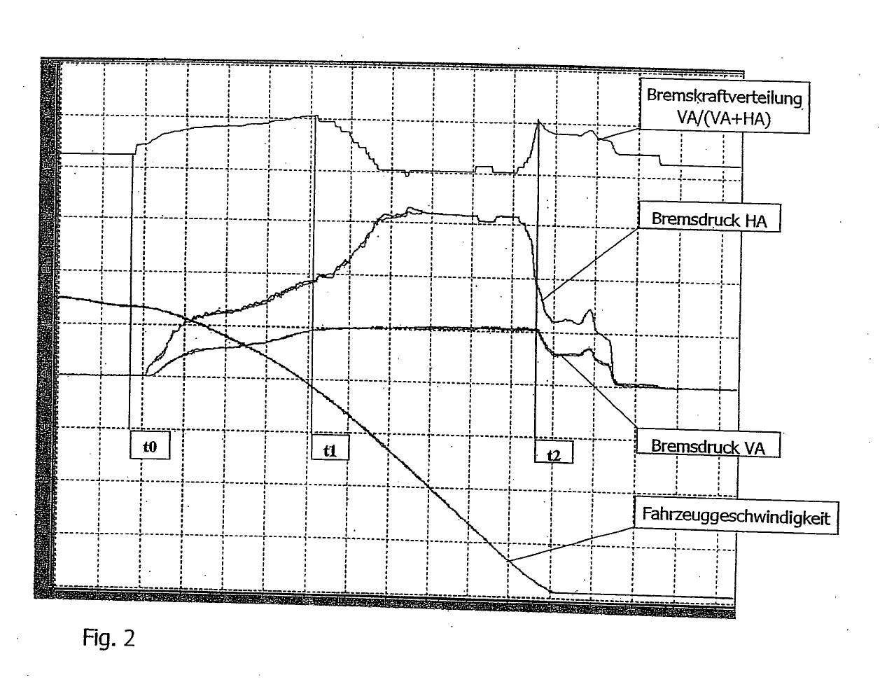

To prevent resonance effects and/or undesirable noise generation, in the vehicle brake system 10 according to the first embodiment it is provided that by means of the evaluation device 18 critical combinations of wheel peripheral speed and associated wheel brake pressure are detected already in the run-up to a resonance-related noise generation. If noise generation is to be expected, by means of the regulating device 20 influence is brought to bear upon the brake pressure of the relevant wheel in such a way that during a braking operation critical combinations of wheel peripheral speed and associated wheel brake pressure are avoided. This process of preventing noise generation is now described in detail with reference to FIG. 2.

FIG. 2 is a time diagram illustrating the automatic intervention according to the invention to prevent noise generation. In the time diagram of FIG. 2, for an exemplary braking operation the characteristic curves of several parameters characterizing the braking operation are represented in relative units. The top characteristic curve is the time-dependent course of the brake force distribution. In the case of the example, the brake force distribution is defined as the ratio of the brake force fraction of the front axle VA to the total brake force at front and rear axle VA+HA. The reason for the axlerelated definition of the brake force distribution is the fact that the brake pressure is also set in an axle-related manner. Should the brake pressure be set in a wheel-related manner, a wheel-related brake force distribution might be defined.

Below the characteristic curve of the brake force distribution, the time-dependent course of the brake pressure at the rear axle HA and, below it, the time-dependent course of the brake pressure at the front axle VA are shown in the diagram of FIG. 2. The bottom characteristic curve reflects the time-dependent course of the vehicle speed. Clearly visible is the substantially uniform reduction of the vehicle speed resulting from the actuation of the vehicle brake system.

If at time t0 a driver initiates a braking operation, the brake pressures at the front axle and rear axle gradually increase. At the same time, the vehicle speed starts to drop. The brake force distribution presents a characteristic course that is defined by means of a usually provided brake force distributor.

During the braking operation, in the region of each of the four wheel brakes 14A. . . 14D of the vehicle brake system 10 according to the first embodiment a wheel-related monitoring of the wheel peripheral speed and the associated wheel brake pressure or, synonymously, of the associated wheel brake force is effected. The monitoring occurs for each wheel individually by means of the evaluation device 18 coupled to the individual sensor devices 16A. . . 16D. In the evaluation device 18 the parameters acquired by the sensor devices 16A. . . 16D, namely the wheel peripheral speed and the wheel brake pressure, are compared with previously defined limit values. In said case, it is provided that the evaluation device 18 activates the brake pressure regulating device 20 only if, at a wheel, the limit value of the brake force or the limit value of the wheel peripheral speed is exceeded. It might alternatively be provided that an activation of the regulating device 20 occurs only if both limit values are exceeded. It might also be conceivable to define wheel peripheral speed windows and/or brake force windows with upper and lower limit values. In this case, an activation of the regulating device 20 occurs only if one of the two relevant parameters or both parameters lies or lie within the critical parameter range defined by the upper and lower limit values.

In the scenario illustrated in FIG. 2, at time t1 at the two wheel brakes 14A, 14B of the front axle VA a brake pressure limit value is reached, which if exceeded may lead to braking noises. The evaluation device 18 therefore activates the regulating device 20. The regulating device 20 then generates commands to change a standard brake force distribution between the wheel brakes of the front axle, on the one hand, and the wheel brakes of the rear axle, on the other hand. The commands are geared towards achieving the effect whereby, on the one hand, the brake pressure at the noise-critical wheel brakes 14A, 14B of the front axle VA does not exceed the brake pressure limit value (pressure limitation) but, on the other hand, the brake pressure at the wheel brakes 14C, 14D of the rear axle HA increases to such an extent that the sum of the brake pressures and hence the desired vehicle deceleration do not change. The driver of the motor vehicle is consequently totally unaware of the automatic intervention into the brake force distribution. This is clear from the fact that the vehicle speed, despite the control intervention, falls even after time t1 with a substantially constant slope.

At time t2 the braking operation has progressed to such an extent that the brake pressure at the wheel brakes 14A, 14B of the front axle VA may (likewise) be reduced. In other words, at time t2 there may be a switch back to the original (standard) brake force distribution.

The intervention according to the invention into the brake force distribution consequently occurs for the length of time t2-t1 . In the time diagram according to FIG. 2 it may clearly be seen that during this length of time the brake force distribution among the wheel brakes 14A. . . 14D changes. It should however be taken into account that the intervention into the brake force distribution between t1 and t2 generally does not involve an intervention into the course of the total brake force. For this reason, by means of the intervention into the brake force distribution between t1 and t2 the occurrence of undesirable noises may be prevented without changing the vehicle deceleration desired by the driver (or set e.g. by a control system).

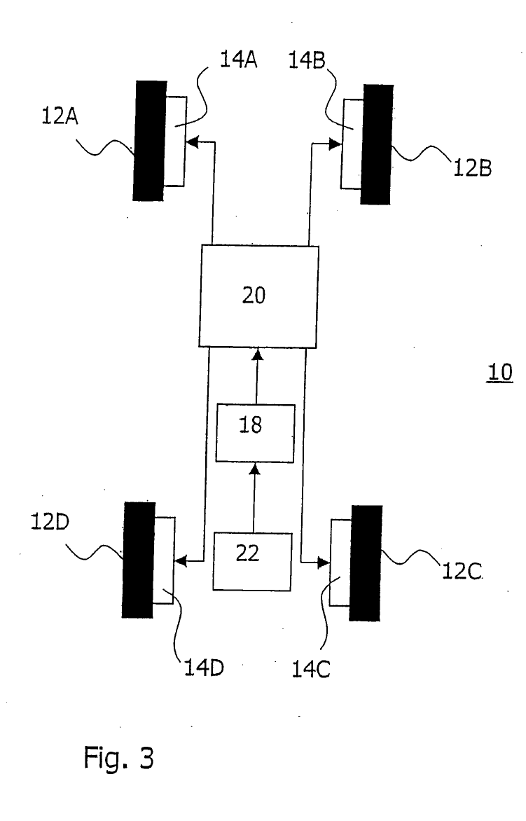

In FIG. 3 a further vehicle brake system 10 according to a second embodiment of the invention is illustrated. Identical components are denoted by the same reference characters as in the vehicle brake system of the first embodiment.

Unlike the first embodiment, in the vehicle brake system 10 illustrated in FIG. 3 the brake pressures are set, not axle by axle, but wheel by wheel. A further difference lies in the fact that in the second embodiment the noise generation is acquired directly by means of a noise sensor 22. This means that in the second embodiment noise generation is not prevented, rather noises that have already occurred or the swelling of noises that have already occurred is to be suppressed.

As may be seen from FIG. 3, the noise sensor 22 (e.g. a microphone) is disposed in the region of the wheel brakes 14C, 14D of the rear axle. The output signal of the noise sensor 22 is evaluated by the evaluation device 18. The evaluation is geared towards detecting the reaching of a noise threshold value. If the noise threshold value is reached, the evaluation device 18 activates the regulating device 20 and the previously discussed control intervention illustrated in FIG. 2 occurs.

As regards the design of the noise sensor 22, various possibilities are available. For example, it is conceivable to integrate the noise sensor 22 in a brake lining wear sensor. Another possibility is to fit noise sensors on the individual vehicle wheels and inject the signals produced by the noise sensors into wheel peripheral speed sensors and transmit them jointly with signals of these sensors. Piezoelectric elements, for example, may be used as noise sensors.

There now follows a description of several developments of the invention that apply both to the vehicle brake system according to the first embodiment and to the vehicle brake system according to the second embodiment.

It has proved advantageous, for detecting the occurrence or imminent occurrence of noises, simultaneously to take into account further parameters such as the laden state of the vehicle, the static and dynamic force distribution of the vehicle, uphill and/or downhill braking operations, cornering braking operations with increased transverse acceleration, and braking operations on so-called split mue roads, etc. This information is generated by brake pressure regulating devices with ESP functionality that are usually already provided.

It has further emerged that, in the event of braking operations or driving manoeuvres that are critical in terms of stability and lead to the activation of safety-relevant control mechanisms such as ESP or ABS, these control mechanisms should be given priority over the previously described, noise-reducing control mechanisms. In other words, safety aspects should not be neglected in favour of comfort aspects.

To prevent uneven wear of the brake linings, the interventions into the brake force distribution may be effected in such a way that in the region of a specific wheel brake, in the event of successive, noise-related changes of the brake force distribution, the brake force is alternately increased and reduced. If, for example, during an intervention into the brake force distribution at specific wheels the brake forces are reduced and at other wheels the brake forces are increased, then during the next noise-related intervention into the brake force distribution at the individual wheels brake force changes in the opposite direction should be used to compensate.

The comparison curves used by the evaluation device to evaluate the sensor signals may be determined as early as during the brake design stage and then stored in the evaluation device or a separate device. After delivery of the vehicle, the comparison values may if necessary be altered and/or adapted when the vehicle is in the workshop (e.g. for servicing). For this purpose, the evaluation device or the separate device may be provided with an interface that affords access to memory areas for the purpose of altering or supplementing relevant parameters, characteristics maps (e.g. a look-up table) etc.

The parameters for detecting the occurrence or imminent occurrence of noises that are stored in e.g. a look-up table may include one or more of the values: wheel brake pressure, wheel speed (wheel rotational speed), temperature, brake wear (e.g. time factor, brake abrasion or running capacity). It is also conceivable, when exchanging components of the brake system such as e.g. the brake linings, to use the interface to load new parameters, characteristics maps, etc., which take into consideration the characteristic properties of the exchanged components.

Compared to noise absorption by means of additional masses, intervention into the brake force distribution makes it possible to shorten development times and reduce fuel consumption. At the same time, it is not impossible, for particularly effective noise reduction, to combine the intervention according to the invention into the brake force distribution with the provision of additional masses.

In accordance with the provisions of the parent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. Method of automatically suppressing or preventing noise generation during the actuation of a vehicle brake system 10 comprising one or more wheel brakes, having the steps:
generate brake forces by means of the wheel brakes (14A. . .14D);
acquire at least one parameter that allows a conclusion to be drawn about possible noise generation;
evaluate the parameter to detect the occurrence or imminent occurrence of noises;
characterized by the step of changing a brake force distribution if the evaluation reveals the occurrence or imminent occurrence of noises, wherein the brake force distribution is changed while simultaneously retaining a desired or set vehicle deceleration.

2. Method according to claim 1, wherein the change of the brake force distribution also includes at least one wheel brake, at which no noise generation occurs or is to be expected.

3. Method according to claim 1, wherein changing of the brake force distribution includes the preventing of a further rise of the brake pressure at a wheel brake affected by the noise generation.

4. Method according to claim 1, wherein the at least one parameter is evaluated for the existence or imminent occurrence of a critical condition and the changing of the brake force distribution is geared towards the critical condition being no longer met or its occurrence being prevented.

5. Method according to claim 1. wherein, in the event of successive, noise-related changes of the brake force distribution, the brake force at one of the wheel brakes or axles is generally alternately increased and reduced.

6. Method according to claim 1 wherein, to change the brake force distribution, use is made of one or more brake pressure regulating devices 20 that are provided also for other purposes, such as ABS, ASR or ESP.

7. Method according to claim 1, wherein changing of the brake force distribution is effected in a controlled manner that simultaneously takes into consideration a resulting change of the at least one acquired parameter.

8. Method according to claim 1, wherein the noise generation is directly acquired.

9. Method according to claim 1, wherein at least one of the parameters: wheel peripheral speed, wheel brake force and wheel brake pressure is acquired.

10. Method according to claim 1, wherein the acquisition and evaluation of the at least one parameter is effected in a wheel-related manner.

11. Method according to claim 1, wherein the acquisition and evaluation of the at least one parameter is effected in an axle-related manner.

12. Method according to claim 1, wherein changing of the brake force distribution is effected in an axle-related manner.

13. Method according to claim 1, wherein changing of the brake force distribution is effected in a wheel-related manner.

14. Vehicle brake system 10, comprising
two or more wheel brakes;
at least one sensor for acquiring at least one parameter that allows a conclusion to be drawn about possible noise generation;
an evaluation device 18 for evaluating the at least one parameter for the occurrence or imminent occurrence of noises;
characterized by a command generating device 20 for generating commands to change a brake force distribution if the evaluation reveals the occurrence or imminent occurrence of noises, wherein the change of the brake force distribution is effected while simultaneously retaining a desired vehicle deceleration.

15. Vehicle brake system according to claim 14, wherein the vehicle brake system (10) is based on the brake-by-wire principle.

16. Vehicle brake system according to claim 14, wherein the command generating device (20) comprises one or more brake pressure regulating devices provided also for other purposes, such as ABS, ASR or ESP.

17. Method according to claim 1, wherein the acquisition or evaluation of the at least one parameter is effected in a wheel-related manner.

18. Method according to claim 1, wherein the acquisition or evaluation of the at least one parameter is effected in an axle-related manner.
